(19) United States
(12) Patent Application Publication
(10) Pub. No.: US 2003/0207128 A1
(43) Pub. Date: Nov. 6, 2003

(54) Thermally conductive sheet

(76) Inventors: Tomoaki Uchiya, Hachioji-city (JP); Yoshinao Yamazaki, Sagamihara-city (JP); Mitsuhiko Okada, Sagamihara-city (JP)

Correspondence Address: 3M INNOVATIVE PROPERTIES COMPANY, PO BOX 33427, ST. PAUL, MN, 55133-3427, US

(21) Appl. No.: 10/239,266

(22) PCT Filed: Mar. 15, 2001
(86) PCT No.: PCT/US01/08231

(30) Foreign Application Priority Data
Apr. 10, 2000 (JP) 2000-113260

(51) Int. Cl. B32B 9/04

(52) U.S. Cl. 428/447

(57) ABSTRACT

A thermally conductive sheet comprising a heat-conductive resin layer. The heat-conductive resin layer comprises a binder resin comprising a wax, and a heat-conductive filler dispersed in the binder resin. The thermally conductive sheet has flexibility, and is conformable to a specific shape such as uneven or curved face, thereby ensuring high adhesion, and at the same time, ensuring high heat conductivity without causing any defect ascribable to the addition of a heat-conductive filler.

### FIELD OF THE INVENTION

The present invention relates to a thermally conductive sheet, more specifically, the present invention relates to a thermally conductive sheet useful in a heat transfer medium of electronic parts and the like. The thermally conductive sheet of the present invention can be advantageously used as a heat transfer medium for removing heat from heat-generating electronic parts and other parts (hereinafter collectively called “heat-generating parts”) integrated in electronic instruments such as electronic devices like personal computers and printed circuit boards.

### BACKGROUND ART

Heretofore, in order to allow the heat generated in heat-generating parts to escape outside, for example, a radiator such as heat-radiating fin or metal cooling wheel is fixed to the heat-generating parts. In this connection, various thermally conductive sheets are being used as a heat transfer spacer (heat transfer medium) by disposing it between a heat-generating part and a heat-radiating member.

Conventional thermally conductive sheets are obtained in many cases by blending a packing material (also called a filler) capable of increasing the heat conductivity with a silicone rubber. Examples of the filler include, for example, alumina, silica (quartz), boron nitride, magnesium oxide and like. To speak more specifically, Japanese Unexamined Patent Publication (Kokai) No. 56-837 discloses a heat-radiating sheet mainly comprising an inorganic filler and a synthetic rubber such as silicone rubber, characterized in that the inorganic filler consists of two components: (A) boron nitride and (B) alumina, silica, magnesia, zinc white or mica. Also, Japanese Kokai Nos. 7-111300, 7-157664 and 10-204295 disclose a similar thermally conductive sheet.

These thermally conductive silicone rubber sheets each can exhibit high heat conductivity, however, they have some problems to be solved. For example, the silicone rubber has a problem in that the silicone rubber itself is expensive and in turn the cost of the heat-radiating sheet increases. In addition, since the silicone rubber used has a low curing rate, the working into a sheet takes a long time. Further, since a large amount of filler should be added so as to increase the heat conductivity, it becomes difficult to produce thin sheets with a high accuracy. Furthermore, the production process of such a sheet is complicated and a large-scale apparatus including a blast stove, a press and the like is necessary for the production. In recent years, thermally conductive sheets mainly comprising a silicone gel have been proposed in order to solve the above-described problems of the silicone rubber sheet and to soften the sheet itself and enable the sheet to conform to the shape of heat-generating parts or radiators, even if these have a specific shape such as uneven surface or curved surface. For example, Japanese Kokai No. 10-189838 discloses a heat-conductive gel useful as a heat-radiating sheet, wherein a condensation-type gel, such as condensation curing-type liquid silicone gel, is used as a binder; a silicone oil and a heat-conductive filler such as boron nitride (BN), silicone nitride (SiN), aluminum nitride (AlN) or magnesium oxide (MgO) are added to the binder; and the resulting mixture is cured into a gel form at room temperature. In fact, when the thermally conductive sheet is softened, the conformability to the uneven surface is improved and voids are less likely formed under the sheet, preventing the increase in heat resistance and obtaining good heat-radiating property. Furthermore, when the sheet is flexible, electronic parts can be protected from damaging due to applied pressure or the like. However, if a heat-conductive filler such as BN, SiN, AlN or MgO is added to the silicone gel, the sheet is hardened, adversely affecting the conformability to the uneven surface or the workability and strength of the sheet. These adverse effects are more serious as the amount of the heat-conductive filler added is increased so as to elevate the heat conductivity. In order to prevent the sheet from a hardening phenomenon ascribable to the addition of the filler, it may be considered, as described above, to add silicone oil or other additives to the silicone gel. However, the silicone oil breeds out on the sheet surface and disadvantageously deteriorates the appearance and the properties of the thermally conductive sheet.

### SUMMARY OF THE INVENTION

The present invention is directed to solving the above-described problems of conventional thermally conductive sheets and provide a thermally conductive sheet capable of conforming to a specific shape such as uneven or curved surface and, at the same time, ensuring a high heat conductivity without causing any defect ascribable to the addition of a heat-conductive filler.

The present invention is directed to a thermally conductive sheet comprising a heat-conductive resin layer, wherein the heat-conductive resin layer comprises a binder resin comprising a wax and a heat-conductive filler dispersed in the binder resin.

The thermally conductive sheet comprises a binder resin and a heat-conductive filler. Part of the binder resin is replaced by a wax, which increases the flexibility of the sheet and improves its conformability to unevenness and its heat-radiation property. In addition, the sheet is prone to plastic deformation, reducing the stress remaining after the application of a pressure and damage to the electronic parts and the like. The binder resin preferably comprises organopolysiloxane.

### DETAILED DESCRIPTION OF THE INVENTION

The thermally conductive sheet of the present invention includes a heat-conductive resin layer. In some embodiments, the heat-conductive resin layer is supported by a backing. When the backing is used in the thermally conductive sheet, the heat-conductive resin layer may be formed on only one surface of the backing or may be formed on both surfaces of the backing. Whether to form the heat-conductive resin layer on one surface or both surfaces of the backing may be freely determined according to the use of the thermally conductive sheet or other factors. If handling is required, it is usually preferred to form the heat-conductive resin layer on only one surface of the backing. In such a case, the backing and the heat-conductive resin layer both are preferably as thin as possible.

The heat-conductive resin layer integrated into the thermally conductive sheet of the present invention is constructed to contain at least a binder resin comprising a wax and a heat-conductive filler dispersed in the binder resin.

The heat-conductive resin layer may be formed using a commonly used binder resin (also called binding resin) as the main agent. Examples of the binder resin suitable as the main agent used in the formation of the heat-conductive resin layer include, for example, silicone-based resin (organopolysiloxane containing as a principal component thereof polymethylsiloxane and the like; hereinafter referred to “organopolysiloxane”), urethane-based resin, synthetic rubber-based resin and acrylic resin. Among these resins, since they enable to exclude a solvent and to charge a high concentration of fillers, 2-part curing organopolysiloxane and urethane-based resin can be advantageously used. Most preferably, silicone gel can be used, because silicone gel exhibits a low crosslinking density and a good flexibility over a wide temperature range.

The 2-part curing silicone gel includes various resins. However, any 2-part curing resin may be used as long as it satisfies the requirements such that a volatile matter is not contained, the pot life after the mixing of two liquids is sufficiently long not to disturb the production, the curing time is in the practical range, specifically from a few minutes to a few hours, and the cured resin can exhibit satisfactory softness.

More specifically, the silicone gel comprises an organopolysiloxane having an alkenyl group and an organopolysiloxane having a silicon-bonded hydrogen atom as main components. Examples of such organopolysiloxane are commercially available as an addition reaction curing-type silicone from, for example, Toray Dow Corning Silicone, Shinetsu Silicone and GE Toshiba Silicone. Such a silicone composition includes two types, namely, a one part liquid curing type and a two part liquid curing type. A flexible gel can be obtained by heating the one part liquid curing-type silicone composition or in the case of the two part liquid curing-type silicone composition, by heating the composition after mixing two liquids. The two part liquid curing-type silicone composition is preferred.

In the thermally conductive sheet of the present invention, it is necessary that the binder resin comprises a wax, preferably a low melting point wax. It is generally preferred that the low melting wax has a melting point of between about 40 and about 120° C. The wax may be any one of naturally occurring waxes and synthetic waxes, and it may be used alone or as a mixture or combination thereof. If the melting point of the wax is less than about 40° C., the wax may be softened in summer, thereby increasing its fluidity, so that the wax may easily bleed on a surface of the sheet, in addition to too soft sheet with poor handling property. If the melting point of the wax exceeds about 120° C. and amount of the wax is increased, too stiff sheet is produced, thereby lowering compatibility with a surface of heat-generating parts.

According to the present invention, a part of the binder resin is replaced by a wax, so that the thermally conductive sheet can be softened and in the practical use, the heat resistance is decreased. More specifically, in this thermally conductive sheet, the wax melts when the silicone gel or the like is cured or when the thermally conductive sheet is integrated into an electronic instrument and actually used. As a result, the thermally conductive sheet undergoes plastic deformation. By virtue of this plastic deformation, the stress imposed on integrating the thermally conductive sheet into a final product such as an electronic instrument is reduced. This flexibility is particularly important in the case where the thermally conductive sheet is used in parts prone to damages by an applied pressure or the like.

In selecting the wax having a melting point of approximately from about 40 to about 120° C., the chemical composition is not particularly limited. However, waxes free of impurities which may inhibit the addition reaction of the silicone gel are preferred. Those having good compatibility with the silicone gel also are preferred. If the compatibility is bad, the wax bleeds out on the sheet surface after the formation thereof and reduces the tack of the sheet.

In general, the wax has a weight average molecular weight (Mw) of from about 200 to about 1,000. The wax having such a low molecular weight and also having a low polarity exhibits relatively good compatibility with the silicone gel and, since it is a solid at room temperature, the wax does not bleed out on the sheet surface during storage in an ordinary state. If the molecular weight of the wax is not within the above-described range, the effect by the addition of the wax to the binder resin may not be sufficiently exerted.

Examples of the wax useful in the practice of the present invention include naturally occurring waxes such as animal and vegetable waxes (e.g., carnauba wax, rice wax, candelilla wax), mineral waxes and petroleum waxes (e.g., paraffin wax, microcrystalline wax), and synthetic waxes such as Fischer-Tropsch wax, polyethylene wax, and petrolactum. These waxes may be used separately or as a mixture or combination of two or more waxes.

The shape of the wax may be freely selected, however, a fine grain or powder form is preferred. Furthermore, the wax preferably has a particle size as small as possible so as to attain uniform dispersion. Usually, the particle size of the wax is preferably from about 1 to about 1,000 μm.

The amount of the wax added to the binder resin may be variously changed according to the kind of the wax or the desired addition effect. Usually, the wax is preferably added in an amount of from about 0.01 to about 55 parts by weight per 100 parts by weight of the binder resin. If the amount of the wax added is less than about 0.01 parts by weight, the effect of increasing the flexibility of the sheet decreases, whereas if the amount of the wax added exceeds about 55 parts by weight, satisfactory internal cohesive strength may not be obtained in the sheet.

The heat-conductive filler, which is used together with the binder resin containing the wax in the formation of the heat-conductive resin layer, is not particularly limited as long as it can be uniformly dispersed in the binder resin to provide a heat-conductive resin layer having heat conductivity in a desired level. Various materials commonly used as the filler in the production of thermally conductive sheets may also be used in the practice of the present invention. Examples of appropriate fillers include inorganic materials, preferably ceramic materials, such as silicon carbide (SiC), boron nitride (BN), silicon nitride (Si₃N₄), aluminum nitride (AIN), magnesium oxide (MgO) and aluminum oxide (Al₂O₃). These fillers may be used separately or as a mixture or combination thereof.

In general, the inorganic filler is advantageously used in the form of a particle.

The particle size of the filler may be varied over a wide range. A preferred particle size is usually from about 1 to about 200 μm. If the particle size of the particulate filler is less than about 1 μm, an amount of the particles charged is reduced as a result of increased surface area of the particles, which may cause insufficient heat radiation. If the particle size of the particulate filler exceeds about 200 μm, the resulting sheet becomes too stiff.

The inorganic particulate fillers may be used individually or in combination of two or more. Two or more inorganic particulate fillers different in particle size, which may be the same or different material, are preferably used in combination. When a combination of two types of fillers is used, it is preferred that one is particulate silicon carbide having a smaller specific surface area, namely, larger particle size than that of the other, and the other can be particulate boron nitride having a smaller particle size than that of the above particulate silicon carbide. If desired, particulate boron nitride fillers different from each other in particle size may be used. The term “particulate” is used broadly and includes not only those generally called a particle but also those called a powder or fine particle.

When the binder resin is a silicone gel and the inorganic filler dispersed therein is a combination of particulate silicon carbide and particulate boron nitride having a particle size smaller than that of the particulate silicon carbide, the following remarkable operational effects can be obtained. By using a combination of two kinds of particulate fillers and adjusting the blending ratio, the properties of respective particulate fillers can be fully brought out, so that the heat conductivity can be increased without impairing the softness of the silicone gel and the workability at the sheet formation can be improved. Actually, the thermally conductive sheet obtained in this way can exhibit excellent flexibility as compared with conventional silicone rubber-made thermally conductive sheets. In addition, those two kinds of particulate fillers are dispersed in the silicone gel such that small boron nitride particles are embedded in voids generated between the distributed large silicon carbide particles. Therefore, dense packing can be attained, greatly contributing to the improvement of the heat conductivity and other effects.

The particulate silicon carbide as a first filler has been used as a filler in conventional silicone rubber-based thermally conductive sheets. In general, particulate silicon carbide used as an abrasive in the industrial field can be used. The particulate silicon carbide is not particularly limited in shape and can have, for example, a spherical form. The particle size of the particulate silicon carbide can be broadly varied according to the desired effect and the particle size of the particulate boron nitride used at the same time; usually, the particle size of the particulate silicon carbide is preferably from about 1 to about 200 μm, more preferably from about 10 to about 100 μm. The particulate silicon carbide is very small in the specific surface area as compared with other particulate fillers and therefore, when this is used in combination with particulate boron nitride, as described above, the filling density of filler particles can be elevated to a maximum level and at the same time, the heat conductivity can be greatly improved.

The particulate boron nitride as a second filler has also been used as a filler in conventional silicone rubber-made thermally conductive sheets. The particulate boron nitride includes various particulate types, however, in general, use of hexagonal particulate boron nitride is preferred because of its excellent heat conductivity. The particulate boron nitride is not particularly limited in shape and may have, for example, a spherical or plate grain form. For example, when the particle size of the particulate silicon carbide is about 50 μm, the particle size of the particulate boron nitride used at the same time is preferably less than about 50 μm specifically, from about 10 to less than about 50 μm. The term “particle size” is an average value and since the particles as obtained exhibit a size distribution, some of the particles used in the practice of the present invention are allowed to deviate from the specified dimension.

In such a composite particulate filler, the mixing ratio between the particulate silicon carbide and the particulate boron nitride can be broadly varied according to the desired effect. In general, the particulate silicon carbide is preferably mixed in an amount of from about 100 to about 800 parts by volume per 100 parts by volume of the particulate boron nitride, more preferably from about 150 to about 700 parts by volume per 100 parts by volume of the particulate boron nitride. If the amount of the particulate silicon carbide mixed is less than about 100 parts by volume, the total surface area of the particulate filler mixture increases and the maximum filling ratio of the filler to the silicon gel decreases.

As a result, a sufficiently high heat conductivity may not be obtained. On the other hand, if the amount of the particulate silicon carbide mixed exceeds about 800 parts by volume, the mixing ratio of the particulate silicon carbide having a high heat conductivity to boron nitride is reduced, and a sufficiently high heat conductivity may not be obtained.

If desired, the third heat-conductive filler may be added in addition to the first and second heat-conductive fillers mentioned above. Examples of suitable third filler include whiskers and fiber-like fillers, in addition to the above-mentioned particulate fillers.

The heat-conductive filler can be mixed with the silicone gel or other binder resin by varying the amount of the filler according to the desired effect. In general, the mixing ratio between the binder resin and the filler is preferably such that the filler is mixed in an amount of from about 90 to about 150 parts by volume per 100 parts by volume of the binder resin, more preferably such that the filler is mixed in an amount of from about 100 to about 140 parts by volume per 100 parts by volume of the binder resin. If the amount of the filler mixed is less than about 90 parts by volume, the heat conductivity excessively decreases, whereas if it exceeds about 140 parts by volume, not only do the mixing of the binder resin and the filler and the formation of the thermally conductive sheet become extremely difficult, but also the sheet obtained is very brittle and may not endure the practical use.

The heat-conductive resin layer may contain any additive, if desired, in addition to the wax-containing binder resin and the heat-conductive filler. Examples of suitable additives include a surface active agent, an antioxidant, a flame retardant and the like. For example, the antioxidant is effective in preventing aging deterioration of the wax and the flame retardant can impart flame resistance to the thermally conductive sheet.

The heat-conductive resin layer can be formed into a predetermined thickness by known film formation methods such as coating or conventional sheet formation method.

The sheet formation method is advantageously used to form a sheet-like resin layer, whereas various layer constituent components described above are stepwise kneaded simultaneously or in an arbitrary order and the kneaded product, a film-forming resin composition, preferably a heat-conductive compound, is formed into a sheet on a liner by a sheet-molding machine.

The heat-conductive resin layer can be varied in the thickness according to the end use of the thermally conductive sheet or the site to which the thermally conductive sheet is applied. Usually, the thickness is from about 0.05 to about 4.0 mm, preferably from about 0.10 to about 2.5 mm. If the thickness of the heat-conductive resin layer is less than about 0.05 mm, workability during application of the sheet onto the heat-generating parts and the heat-radiating parts is lowered, the sheet is broken and air is introduced between the heat-generating part and the heat-radiating part. As a result, a sufficiently high heat-radiating property may not be obtained. If it exceeds about 4.0 mm, the sheet is increased in the heat resistance, and the heat-radiating property may be impaired.

In the thermally conductive sheet of the present invention, to improve the workability during its application to the heat-generating parts, it is effective to carry the heat-conductive resin layer with a backing. The backing for the heat-conductive resin layer is not limited as long as the object of the present invention can be attained, however, plastic film, metal foil, and pressure sensitive adhesive single coated film are preferred. An optimal backing may be selected and used according to the formation method of the thermally conductive sheet, the end use and the site to which the thermally conductive sheet is applied. The backing is usually used as a single layer. If desired, a stacked or other multiple layer backing consisting of two or more layers may also be used.

Examples of the plastic film useful as the backing include, but are not limited to, polyolefin film and polyester film. A film having good heat conductivity and weatherability and exhibiting a relatively high strength as the backing is preferred. Suitable examples of the polyolefin include polyethylene film, polypropylene film, EVA film, EAA film and ionomer film. Among these polyolefin films, high-density polyethylene and polyethylene having an ultrahigh molecular weight are preferred because these are thin, strong and relatively high in heat conductivity. The polyolefin film may be widely varied in the thickness according to various factors. Usually, the thickness is from about 1 to about 25 μm. If the thickness of the polyolefin film is less than about 1 μm, even in the case where the film-forming resin composition is coated on a backing born on a support to stack layers, a thin film free of defects is difficult to form. If the film thickness exceeds about 25 μm, the heat resistance increases in the sheet thickness direction and the heat-radiating property may deteriorate. Incidentally, in the case of ordinary film formation where the film-forming resin composition is interposed between two release films and the resulting stacked body is pressed by passing it through two rollers or by a press, the thin polyolefin film may wrinkle, tear or elongate. However, in the present invention, the resin composition is previously stacked on a backing born on a support before the formation of a sheet, eliminating these problems. This also applies where a metal foil or pressure sensitive adhesive single coated film, which are described below, is used as the backing in place of the plastic film.

Examples of the metal foil useful as the backing include materials such as aluminum, copper, gold, silver, lead, and stainless steel. The term “foil” generally means having a small thickness. The metal foil may be widely varied in the thickness according to various factors, however, similarly to the plastic film, preferably has a thickness as small as possible. Usually, the thickness is suitably from about 1 to about 20 μm. If the thickness of the metal foil is less than about 1 μm, laminating the metal foil to a support becomes difficult. If the thickness of the metal foil exceeds about 20 μm, the backing flexibility is reduced and the conformability decreases.

A pressure sensitive adhesive single coated film can also be used as the backing. This film has a pressure sensitive adhesive layer on one surface. Therefore, the working of laminating the backing to a support can be efficiently performed. For the pressure sensitive adhesive single coated film, an optimal film can be selected from commercially available films and used. Usually, the thickness of the pressure sensitive adhesive single coated film is, similar to the polyolefin film thickness, suitably from about 1 to about 25 μm.

The thermally conductive sheet can be produced by previously placing and fixing a backing on an appropriate support and while keeping such a state, forming a heat-conductive resin layer on the surface of the backing. The production method includes the following steps, though various modifications can be made within the scope of the present invention:

(1) a step of providing a backing on a support;

(2) a step of applying a film-forming resin composition comprising a binder resin, a wax, a heat-conductive filler and the like, to the surface of the backing opposite the surface in contact with the support, to form a heat-conductive resin layer; and

(3) a step of separating the obtained thermally conductive sheet from the support.

The support used for bearing the backing is not particularly limited, however, a film formed of a material having excellent properties such as heat resistance, strength and dimensional stability is preferred. For this support film, a film formed of almost the same materials and having almost the same thickness as a release film (cover film) used in combination at the rolling to form a thermally conductive sheet is preferred. An example of the film suitable as the support includes a biaxially stretched polyester film, biaxially stretched polypropylene film, engineering plastic film and the like.

In the production method of the thermally conductive sheet, first, a predetermined amount of filler particles are prepared and mixed with separately prepared low melting point wax and silicone gel stock solution. During mixing, the mixture is thoroughly mixed until the filler particles and the low melting point wax are uniformly dispersed in the silicone gel. This increases the viscosity of the mixture. A mixing apparatus such as kneader or planetary mixer can be used as the mixing apparatus.

Thereafter, the mixture is applied to an appropriate backing and formed into a sheet on the backing. Before application of the resin mixture to the backing, the backing is preferably placed in contact with a support. Usually, the process of contacting the backing with a support can be performed by stacking the backing on a support. Examples of stacking include a method of coating a pressure sensitive adhesive on the surface of a support by a gravure roll coater and then laminating the backing onto the support; a method of laminating a removable pressure sensitive adhesive tape having a low adhesive strength, such as surface protected pressure sensitive adhesive tape having already coated thereon a pressure sensitive adhesive, onto a backing; and a method of coating a backing-forming composition such as polyolefin resin directly on the surface of a support to form a film.

During laminating of the backing onto a support, for example, when a biaxially stretched polyester film is used as the support and a high-density polyethylene film is used as the backing, a removable acrylic pressure sensitive adhesive having good adhesion to a polyester film may be used as the adhesive for laminating those two members. If a thermally conductive sheet having high adhesion is intended to be obtained as a final product, a release film subjected to a release treatment (preferably a treatment with silicone) can be used as the support and a pressure sensitive adhesive having a high adhesive strength can be used as the adhesive for laminating the members.

If desired, a primer treatment may be applied to the surface of the backing laminated in contact with the heat conductive adhesive, so as to increase the adhesion to the heat-conductive resin layer. If the backing used is a plastic film such as polyolefin film, a surface treatment such as corona discharge treatment may be applied. Furthermore, if a silicone gel is used as the binder resin, a primer for a silicone-based pressure sensitive adhesive may be applied on the backing surface.

After stacking the backing on a support, the stacked body including the support, the backing, and the sheet-forming mixture is formed into a sheet. On the surface of this stacked assembly, a release film (cover film) is applied. The formation of the mixture into a sheet can be performed by rolling. Various rolling methods may be used, including a method of guiding the stacked body between two calendaring rollers and performing calendar formation, and a method of pressing the assembly. Finally, the sheet obtained is heated by an appropriate heating apparatus.

The thermally conductive sheet obtained by this process can usually show a high heat conductivity of 2.0 W/m•K or more due to the composition of the heat-conductive resin layer.

Using the thermally conductive sheet of the present invention, born on a backing, the process of stripping it from the liner when attaching it to a heat-generating part, or repositioning it on the part can be accomplished without elongating the sheet. In addition, because of excellent handleability as compared with thermally conductive sheets without a backing, integrating the heat-generating parts can be improved.

### EXAMPLES

The present invention is described below by referring to the Examples, however, it should be understood that the present invention is not limited to the following Examples. In the Examples, unless otherwise indicated, the “parts” means “parts by weight.”

### Example 1

A silicone gel raw material (trade name “CY52-276”, from Toray Dow Corning Silicone K. K.) was prepared and Solution A and Solution B thereof were mixed each in an amount of 26.25 parts to prepare a room temperature curing-type silicone gel. This silicone gel was placed in a planetary mixer together with, as shown in Table 1 below, 45 parts of silicon carbide particles (trade name “P-240”, from Nanko Ceramics, average particle size: 75 μm) and 2.5 parts of powdered natural wax (trade name “Seisei Bifun Carnauba S”, from Toa Kasei K. K., melting point: 82.7° C.), and kneaded for 30 minutes under reduced pressure. As a result, a silicone gel compound in the slurry form was obtained.

The obtained silicone gel compound was interposed between two sheets of fluorosilicone-treated polyester liners (trade name “Film Byner SF-3”, from Fujimori Kogyo, thickness: 75 μm) to come into contact with respective liner surfaces, thereby stacking layers. The resulting stacked body was subjected to a calendar formation between two rollers at room temperature and then heated in an oven at 120° C. for 30 minutes to cure the slurry material into the gel. As a result, a thermally conductive sheet having a thickness of 1.0 mm was obtained.

### Testing

To evaluate the heat resistance and the flexibility of the thermally conductive sheet, evaluation tests were performed according to the following procedure.

1. Evaluation of Heat Resistance

To evaluate the heat conductivity of the thermally conductive sheet, the heat resistance of the sheet was measured. The thermally conductive sheet was interposed between a CPU and an aluminum plate and a predetermined pressure was applied to press the sheet to the CPU. Thereafter, a voltage of 7 V was applied to the CPU. After 5 minutes, the difference in the temperature between the CPU and the aluminum plate was measured and the heat resistance was calculated. The heat resistance of the thermally conductive sheet in this example was 7.23° C.cm²/W.

2. Evaluation of Flexibility

To evaluate the flexibility of the thermally conductive sheet, a 10 mm×10 mm specimen was cut from one sheet. A tensilone-type tensile strength tester (trade name “AUTOGRAPH AGS100B”, from Shimadzu Seisakusho) was prepared and the pressure when the specimen was compressed in a compress mode at a rate of 0.5 mm/min was measured. From the stress-strain curve obtained, the compressive strain (%) was read.

The compressive strain of the thermally conductive sheet in this example was 35%.

### Examples 2 to 6

The preparation and tests described in Example 1 were repeated except for changing the composition of the silicone gel compound as shown in Table 1 below. The low melting point waxes used in Examples 5 and 6 were natural wax (trade names “LUVAX-115”, melting point: 105° C. and “LUVAX-032”, melting point: 75° C., respectively, produced by Nippon Seiro K. K). The evaluation test results obtained are shown in Table 1 below.

### Comparative Example 1

The preparation and tests described in Example 1 were repeated except for changing the composition of the silicone gel compound as shown in Table 1 below. More specifically, in Comparative Example 1, Solution A and Solution B of the silicone gel (trade name “CY52-276”) were mixed each in an amount of 27.50 parts and the addition of the low melting point wax (trade name “P240”) was omitted. The evaluation test results obtained are shown in Table 1 below.

TABLE 1

| | Low Melting Point Wax | | Silicone Gel | | | | Heat | |
|---|---|---|---|---|---|---|---|---|
| Example | | Available | [parts by weight] | | Wax | SiC | Resistance | Flexibility |
| No. | Trade Name | From | CY52-276A | CY52-276B | (pbw) | (pbw) | (° Ccm²/W) | (%) |
| Example 1 | Carnauba S | Toa Kasei | 26.25 | 26.25 | 2.5 | 45 | 7.23 | 35 |
| Example 2 | Carnauba S | Toa Kasei | 25.00 | 25.00 | 5.0 | 45 | 7.35 | 34 |
| Example 3 | Carnauba S | Toa Kasei | 23.75 | 23.75 | 7.5 | 45 | 7.55 | 28 |
| Example 4 | Carnauba S | Toa Kasei | 22.50 | 22.50 | 10 | 45 | 7.74 | 24 |
| Example 5 | LUVAX-1151 | Nippon Seiro | 26.25 | 26.25 | 2.5 | 45 | 7.87 | 32 |
| Example 6 | LUVAX-0321 | Nippon Seiro | 26.25 | 26.25 | 2.5 | 45 | 6.97 | 45 |

| | | | | | | | |
|---|---|---|---|---|---|---|---|
| Comparative | None | 27.50 | 27.50 | 0 | 45 | 8.26 | 30 |
| Example 1 | | | | | | | |

pbw: parts by weight

As is understood from the evaluation results shown in Table 1, the thermally conductive sheets according to the present invention all have satisfactory heat resistance and flexibility, thus, proved to have sufficiently high capability as the thermally conductive sheet of electronic parts and the like. It is also seen that as the thermally conductive sheet becomes more flexible, the compressive strain is increased.

As described in the foregoing pages, according to the present invention, the thermally conductive sheet having flexibility, being conformable to a specific shape such as uneven or curved face, thereby ensuring high adhesion, and at the same time, ensuring high heat conductivity without causing any defect ascribable to the addition of a heat-conductive filler, can be provided.

We claim:

1. A thermally conductive sheet comprising a heat-conductive resin layer, the heat-conductive resin layer comprising a binder resin comprising a wax and a heat-conductive filler dispersed in said binder resin.

2. The thermally conductive sheet according to claim 1, wherein the wax has a melting point of about 40° C. to about 120° C.

3. The thermally conductive sheet according to claim 1, wherein the binder resin comprises organopolysiloxane.

4. The thermally conductive sheet according to claim 1 wherein the binder resin comprises an organopolysiloxane having an alkenyl group and an organopolysiloxane having a silicon-bonded hydrogen atom.

5. The thermally conductive sheet according to claim 1 wherein the wax is added in an amount of from about 0.01 to about 55 parts by weight per 100 parts by weight of the binder resin.

6. The thermally conductive sheet according to claim 1 wherein the heat-conductive filler has a particle size of from about 1 μm to about 200 μm.

7. The thermally conductive sheet according to claim 1 wherein the heat-conducive filler is mixed in an amount of from about 90 to about 150 parts by volume per 100 parts by volume of the binder resin.

8. The thermally conductive sheet according to claim 1 further comprising a backing.

9. The thermally conductive sheet according to claim 1 further comprising a pressure sensitive adhesive single coated film adhered to at least a portion of the thermally conductive sheet.

10. A method of manufacturing a thermally conductive sheet comprising:
(a) providing a backing having at least one major surface; and
(b) applying a film-forming resin composition comprising a binder resin, a wax, and a heat-conductive filler to the surface of the backing to form a heat-conductive resin layer.
